(19) United States
(12) Patent Application Publication
(10) Pub. No.: US 2012/0025759 A1
(43) Pub. Date: Feb. 2, 2012

(54) Electric Charger for Vehicle

(75) Inventor: A. Arthur Kressner, Westfield, NJ (US)

(73) Assignee: CONSOLIDATED EDISON COMPANY OF NEW YORK, INC., New York, NY (US)

(21) Appl. No.: 12/848,271

(22) Filed: Aug. 2, 2010

(51) Int. Cl. H02J 7/00

(52) U.S. Cl. 320/108; 320/109; 180/65.21

(57) ABSTRACT

A charger for an electric vehicle is provided. The charge provides for multiple inputs that are combined to provide a single output at higher charging level. The charger includes a toroidal transformer that is electrically coupled between the multiple inputs and the output. The charge may also include a connection to allow an electrical vehicle to communicate with external controllers or servers.

### BACKGROUND OF THE INVENTION

The subject matter disclosed herein relates to a charger for an electric vehicle, and in particular to an electric vehicle charger having at least a pair of inputs for receiving electrical power from multiple electrical circuits.

All-electric and hybrid-electric vehicles store electrical power in a storage device, such as a battery for example. The electrical power is then drawn upon by the vehicle to be converted into useful work, such as by powering motors that are connected to the vehicles wheels. In some vehicles, such as hybrid-electric vehicles for example, the energy stored in the battery is generated by a gasoline fueled engine. The engine rotates an electrical generator that produces electrical power. The electrical power may also be generated using other means such as regenerative braking, which converts the energy dissipated during the braking and slowing down of the vehicle into electrical energy for example.

The all-electric vehicle, which lacks an independently fueled engine, relies on an external power source to provide the energy stored in the battery. The all-electric vehicle includes a receptacle that allows the operator to couple the vehicle to a utility-grid connected electrical circuit. Electrical power is transferred from the grid connected electrical circuit to the vehicle for recharging the batteries. Some all-electric vehicles may also incorporate regenerative braking features as well. A third type of vehicle, the plug-in hybrid electric (“PHEV”) includes an engine for generating power during operation, but also incorporates a receptacle to allow the operator to recharge the battery when the vehicle is not in use. It should be appreciated that the cost of purchasing electrical power from an electrical utility is often more cost effective than combusting the equivalent amount of gasoline in an engine.

In an effort to promote standardization and interoperability, standards have been proposed, such as the J1772 standard promoted by the Society of Automotive Engineers (SAE) for example, that establish defined receptacle parameters and protocols. The J1772 standard provides three different levels of charging. The charging level depends on the capability of the vehicle to receive electrical power and the ability of the electrical circuit to deliver the power.

Level 1 charging allows the vehicle to receive electrical power from a 110 volt, 15-ampere circuit, such as that found in a common residential circuit. Level 1 charging provides an advantage in allowing the operator to connect in many locations using standard circuits, such as those commonly found in a residential garage. However, due to the low power capacity of these electrical circuits, an electric vehicle requires 24-26 hours to fully charge. A Level 2 designated charge allows the vehicle to receive electrical power from a 220V, 30 ampere circuit for example. The Level 2 charge will typically recharge a vehicle battery in three to six hours. These 220V circuits are found in some residences and may be used for certain existing appliances, such as a clothes dryer for example. While 220V circuits may be available at a residence, they are not commonly found in areas where the operator stores vehicles, such as a garage for example. Therefore, in order for an electric-vehicle operator to use a Level 2 charge, the operator may typically need to incur the additional expense of hiring an electrician to install the additional higher capacity circuits. It should be appreciated that in some circumstances the electrical circuits of the residence or facility may not support Level 2 charging and the operator will be limited to a Level 1 rate of charge.

A third charging protocol, known as a Level 3 charge, provides for charging the vehicle using a 440V circuit. The charging of the vehicle on a Level 3 circuit allows the charging of the vehicle battery in two to three hours. Residences with circuits capable of Level 3 charging are not yet common and are typically only available at commercial establishments.

It should be appreciated that a 24-26 hour recharge cycle provided by a Level 1 protocol may be too long to allow daily use of the vehicle. Further, it should be appreciated that if an operator purchases an electrically powered vehicle they may need to either wait for delivery until an electrician installs the Level 2 circuits, or greatly curtail usage of the vehicle until the desired circuits are installed. Since most purchasers of new vehicles find it desirable to utilize their vehicle immediately, these additional steps may curtail or inhibit greater acceptance of electrically powered vehicles.

Accordingly, while existing systems and methods for charging electrically powered vehicles are suitable for their intended purposes, a need for improvements remains in the decreasing of battery charge times without requiring the installation of new or additional higher capacity electrical circuits.

### BRIEF DESCRIPTION OF THE INVENTION

According to one aspect of the invention, an electric vehicle charger is provided. The electric vehicle charger includes a first electrical input, the first electrical input adapted to receive a first electrical power having a first voltage level and a first current level. A second electrical input is provided that is adapted to receive the first electrical power. A toroidal transformer is electrically coupled to the first electrical input and the second electrical input, the toroidal transformer having a first output, wherein the toroidal transformer is adapted to provide a second electrical power having a second voltage level and a second current level to the first output. A second output is configured to electrically couple between a vehicle and the first output.

According to another aspect of the invention, a device for charging a vehicle at a facility having a first electrical circuit and a second electrical circuit is provided. The device includes a first input electrically coupled to the first electrical circuit. A second input is electrically coupled to the second electrical circuit. A transformer is electrically coupled to the first input and the second input, the transformer being configured to combine an electrical power received from the first input and the second input. An output is electrically coupled to the transformer.

According to yet another aspect of the invention, a method of providing an electrical charge to a vehicle is provided. The method includes providing a transformer having an input portion and an output portion. The input portion is electrically coupled to a first input conductor and a second input conductor. The first input conductor is connected to a first electrical circuit and the second input conductor to a second electrical circuit. The output portion is electrically to the vehicle.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic view illustration of an electric vehicle charger in accordance with an embodiment of the invention;

FIG. 2 is schematic diagram illustrating an electric circuit for the electric vehicle charger of FIG. 1;

FIG. 3 is a schematic view illustration an electric vehicle charger in accordance with another embodiment of the invention;

FIG. 4 is a schematic illustration of a utility electrical distribution system;

FIG. 5 is a schematic illustration of a vehicle charging system in accordance with an embodiment of the invention; and,

The detailed description explains embodiments of the invention, together with advantages and features, by way of example with reference to the drawings.

### DETAILED DESCRIPTION OF THE INVENTION

Vehicles that utilize electrical power as a primary energy source typically have a receptacle that allows the vehicle receive electrical power from an external source. The received electrical power is stored in a battery for later use when the vehicle is operated. Typically, the vehicle will have onboard circuitry that controls the flow of electrical power and adapts the electrical characteristics of the electrical power to those desired by the vehicle. Many commercially available electrically powered vehicles comply with Level 1 (110V) and Level 2 (220V) protocols of the Society of Automotive Engineers (“SAE”) standard J1772. The SAE J1772 standard also provides for a third rate of charge known as Level 3 (440V). The charging capacity of the external source is often the limiting factor that determines the rate at which the vehicle's battery will charge.

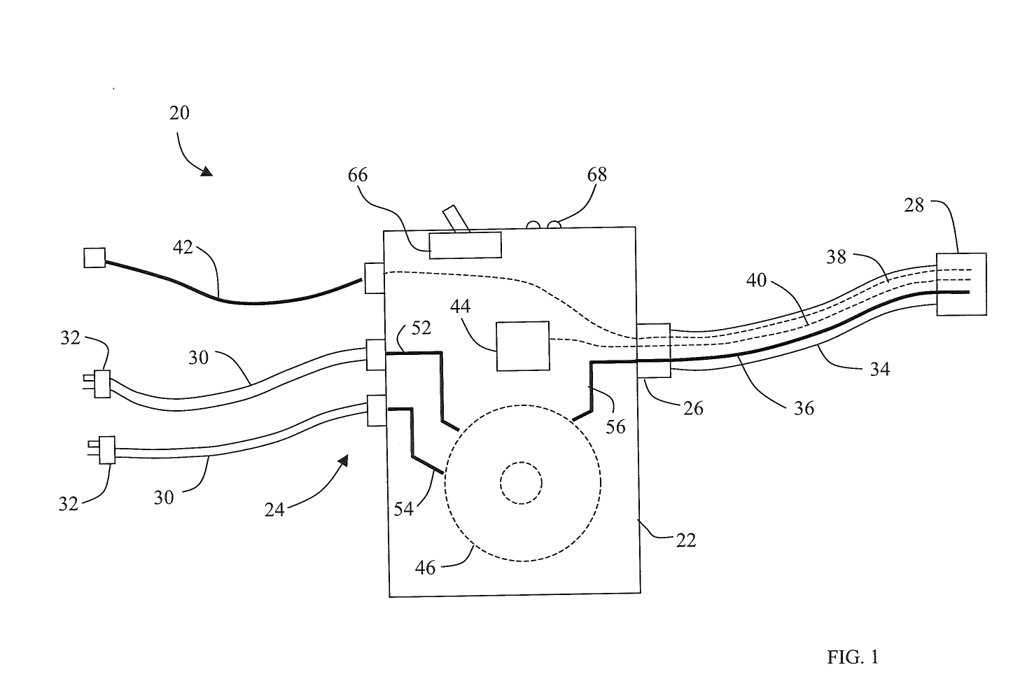

An exemplary embodiment of an electric vehicle charger 20 is illustrated in FIG. 1. The charger includes a housing 22 having a plurality of inputs 24. Each of the plurality of inputs 24 is connected to a conductor 30 having a plug 32 sized to connect with a standard electrical output, such as a National Electric Manufacturers Association (NEMA) 5-15 or a NEMA 6-30 compliant outlet for example. In one embodiment, the conductors 30 are removably connected to the plurality of inputs 24, such that the conductors 30 may be exchanged with connectors having different plug types. The housing 22 further includes an output 26. In the exemplary embodiment, the output 26 is connected by a conduit 34 to a coupler 28 that complies with the SAE J1772 connector standard and is configured to couple with a vehicle receptacle.

In the exemplary embodiment, the conduit 34 contains one or more output conductors 36. As will be discussed in more detail below, the output conductors 36 transfer electrical power to the vehicle. The conduit 34 further includes one or more communication lines 38, 40. The communication lines 38, 40 provide a communications pathway between the vehicle and the electric vehicle charger 20. In one embodiment, the electric vehicle charger 20 includes a first communication line 38 that connects with an output communication line 42. The output communication line 42 may couple to a suitable monitoring or control system, such as but not limited to one or more of: a computer network, a home area network, a wide-area network, a wireless network, or the Internet for example. In another embodiment, the electric vehicle charger 20 may include a second communication line 40 that connects and allows communication between the vehicle and a charger controller 44 within housing 22. It should be appreciated that in some embodiments, the communications line 38, 40 may be integrated into a single communications line.

Arranged between the plurality of inputs 24 and the output 26 is a transformer 46. In the exemplary embodiment, the transformer 46 is a toroidal transformer. The plurality of inputs 24 are connected to the input or primary side of toroidal transformer 46. Output 26 is connected to the load or secondary side of the toroidal transformer 46. It should be appreciated that while the windings of the toroidal transformer 46 are described with a single winding having a primary and a secondary side, other transformer constructions, such as but not limited to a transformer having a separate primary winding and secondary winding may also be used. As will be discussed in more detail below, the toroidal transformer 46 provides advantages in combining the electrical power received via conductors 30 and to allow charging of the vehicle at a higher rate.

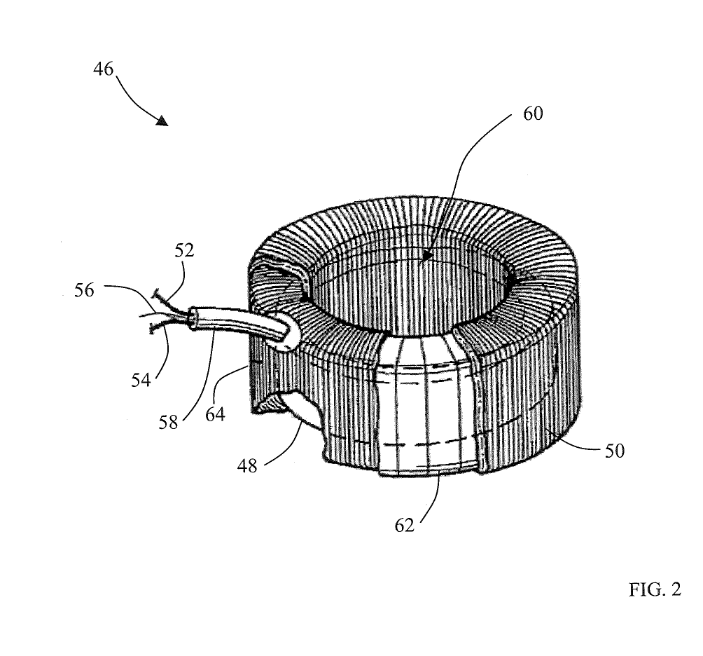

A typical toroidal transformer 46 is described in more detail with reference to FIG. 2. The toroidal transformer 46 includes a core 48 that is covered by an insulation material (not shown). A winding 50 with lead cables 52, 54, 56 and an insulation sleeve 58 wrapped around the cross section of core 48 and distributed along the circumference of the core 48. The cables 52, 54 connect with conductors 30, while the cable 56 connects with output conductor 36. The winding 50 is typically fabricated in a toroidal winding machine by threading a circular winding head with a magazine for storing magnet wire through a center hole 60 in core 48, then storing magnet wire on the magazine, and finally rotating the winding head around the core 48 through the center hole 60 while pealing copper wire off the magazine. The core 48 is rotated slowly about the toroidal axis during winding, so the wire is distributed along the circumference of the core 48.

An insulation portion 62 separates the winding 50 from the transformer core 48. The insulation portion 62 is typically a strip of plastic film that is wrapped in several layers over the transformer core 48. The strips are overlapped laterally to provide creep insulation across the strip. Insulation portion 62 is typically made from a plastic such as, but not limited to polyethylene terephtalate (PEPT) film. The winding 50 is wound on top of the insulation portion 62. A final insulation layer 64 is wrapped around the winding 50 for protection. Alternatively, the toroidal transformer 46 may be potted in plastic to provide the final insulation layer.

The electric vehicle charger 20 may further include additional components, such as but not limited to a switch or circuit breaker 66 and indicator lights or LEDs 68, as shown, for example, in FIG. 1. In the exemplary embodiment, the circuit breaker 66 and LEDs 68 are coupled to controller 44. In one embodiment, the controller 44 includes means for limiting electrical current flowing to the output 26 such as with a variable resistor for example. It should be appreciated that the electric vehicle charger 20 may include additional electrical components for controlling the flow of electrical power through the electric vehicle charger 20 to a vehicle, such electrical components include but are not limited to contactors, relays, fuses, and the like for example. It shall be understood that any “controller”, “controlling device” or other implement receiving inputs from an external device and producing outputs that control the same or another external device may be implemented as a digital microprocessor or as an analog circuit or a combination of both. In the exemplary embodiments, the controller 44 may receive a signal via communication line 40 from the vehicle. In one embodiment, the signal represents a maximum allowable current the vehicle may receive and the controller 44 limits the current level to output 26 to the desired current level in response to the signal from the vehicle. In another embodiment, the controller 44 transmits a signal to the vehicle indicating that the coupler 28 is connected to the vehicle. In yet another embodiment, the controller 44 varies the output electrical power to the vehicle based on a signal received via communication line 40 from the vehicle.

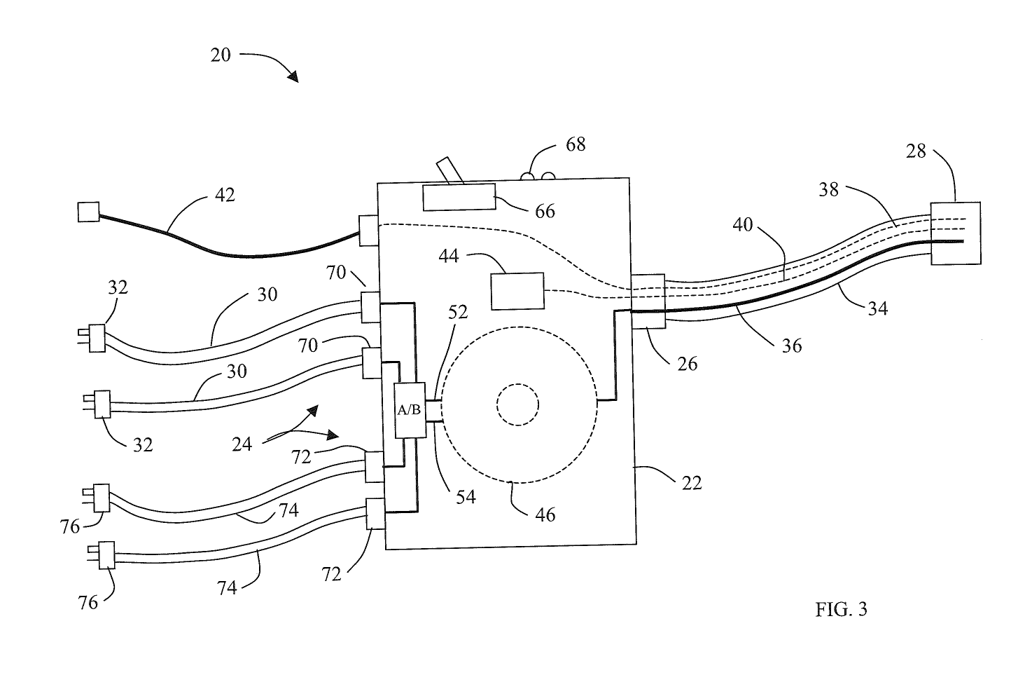

Another embodiment of electrical vehicle electric vehicle charger 20 is illustrated in FIG. 3. This embodiment is substantially similar to the embodiment of FIG. 1. In this embodiment, the plurality of inputs 24 includes a first pair of inputs 70 and a second pair of inputs 72. The first pair of inputs 70 are coupled to receive electrical power from conductors 30 as discussed herein above. The second pair of inputs 72 are coupled to receive electrical power from conductors 74. Similar to conductors 30, the conductors 74 each of a plug 76. In this embodiment, the plugs 76 are configured to couple to a first type of standard electrical outlet, such as a NEMA 6-30 outlet for example, and plugs 32 are configured to couple to a second type of standard electrical outlet, such as a NEMA 5-15 outlet for example. The pairs of inputs 70, 72 are coupled to a switch, such as an A/B switch that selectively couples one of the pairs of inputs 70, 72 to the cables 52, 54, such that only one of the pairs of inputs 70, 72 provides electrical power to the toroidal transformer 46 at a time.

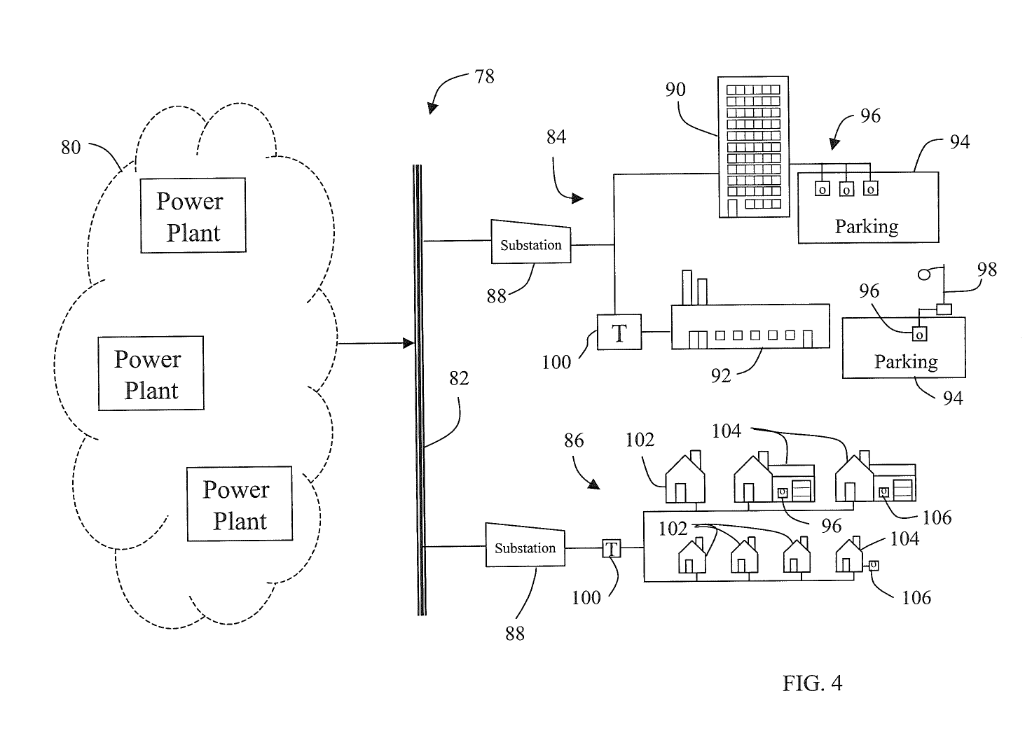

The electric vehicle charger 20 may be used in a variety of applications. An exemplary embodiment of an electrical utility network 78 is illustrated in FIG. 4. The utility network 78 includes one or more power plants 80 connected in parallel and transmit power through a transmission network to a main distribution network 82. The power plants 80 may include, but are not limited to: coal, nuclear, natural gas, or incineration power plants. Additionally, the power plants 80 may include one or more hydroelectric, solar, or wind turbine power plants. It should be appreciated that additional components such as transformers, switchgear, fuses and the like (not shown) may be incorporated into the utility network 78 as needed to ensure the efficient operation of the system. The utility network 78 may be interconnected with one or more other utility networks to allow the transfer of electrical power into or out of the utility network 78.

The main distribution network 82 typically consists of medium voltage power lines, less than 50 kV for example, and associated distribution equipment which carry the electrical power from the point of production at the power plants 80 to the end users located on local electrical distribution networks 84, 86. The local electrical distribution networks 84, 86 are connected to the main distribution network 82 by substations 88 which adapt the electrical characteristics of the electrical power to those needed by the end users. Substations 88 typically contain one or more feeders, transformers, switching, protection and control equipment. Larger substations may also include circuit breakers to interrupt faults such as short circuits or over-load currents that may occur. Substations 88 may also include equipment such as fuses, surge protection, controls, meters, capacitors and voltage regulators.

The substations 88 distribute the received electrical power through feeders to one or more local electrical distribution networks, such as local electrical distribution network 84, for example, that provides electrical power to a commercial area having end users such as an office building 90 or a manufacturing facility 92. These facilities 90, 92 may include parking lots 94 or parking garages. In one embodiment, these parking lots 94 include one or more outlets 96, which operators of electric vehicles may connect the electric vehicle charger 20. In one embodiment, the outlet 96 may be coupled to a streetlight 98. In other embodiments, the outlets 96 are coupled to a facility. Local electrical distribution network 84 may also include one or more transformers 100 which further adapt the electrical characteristics of the delivered electricity to the needs of the end users. Substation 88 may also connect with other types of local distribution networks such as residential distribution network 86. The residential distribution network 86 may include one or more residential buildings 102, 104 and also light industrial or commercial operations. In one embodiment, the residential buildings 104 have outlets 96 adjacent the area where the operators park their electrically powered vehicles.

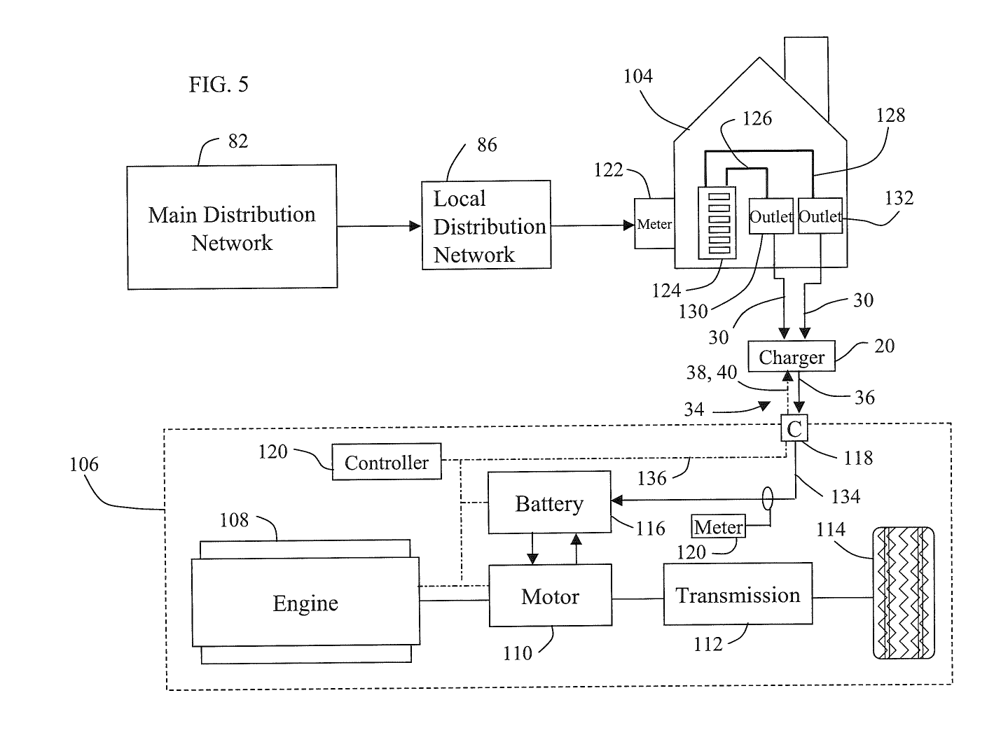

Referring now to FIG. 5, an exemplary embodiment of a system for controlling the recharging of a vehicle will be described. A vehicle, such as a plug-in hybrid vehicle 106 for example, typically includes an internal combustion engine 108 coupled to a motor 110 through a transmission 112 that transfers the power from the engine 108 and motor 110 to the wheels 114. A battery 116 is electrically coupled to provide electricity to power the motor 110. In some embodiments, the motor 110 may be arranged to act as a generator driven by the engine 108 to provide recharging of the battery 116. The vehicle 106 may include a controller 120 that is arranged to communicate and monitor the performance of the vehicle 106. It should be appreciated that the battery 116 is referred to as a single component, however, the battery 116 may be comprised of a number of electrochemical cells or discrete individual batteries that are coupled together in series or parallel, depending on the voltage and power needs. The battery 116 is electrically coupled to a receptacle 118 which provides an external connection to electric vehicle charger 20. A meter 120 is electrically connected between the receptacle 118 and the battery 116 to measure the flow of electrical power to and from the battery 116. The meter 120 may be similar to Applicants co-pending patent application Ser. No. 11/850,113 entitled “Hybrid Vehicle Recharging System and Method of Operation” or Applicants co-pending patent application Ser. No. 12/399,465 entitled “Metering System and Method of Operation” both of which are incorporated herein in their entirety. The controller 120 may also be connected to communicate with external devices, such as the electric vehicle charger 20, via the receptacle 118. It should be appreciated that the meter 120 may be accessible to the controller 120 via the vehicle 106 on-board diagnostic system (e.g. OBD II).

The residence 104 receives electrical power from the main distribution network 82 and local electrical distribution network 86 as described herein above. Typically, the electrical power is received by the residence via an electrical meter 122. The electrical meter 122 has one or more sensors and controllers (not shown) that record the consumption of electrical power by the residence 104. Typically the electrical meter 122 may be a solid state device having features compatible with the Advanced Metering Infrastructure (“AMI”) or Advanced Meter Reading (“AMR”) to allow the electrical meter 122 to communicate with the electrical utility, the residence 104 home area network, the electric vehicle charger 20 or the vehicle controller 120. After the electrical meter 122, the electrical power typically flows into a load center 124 that divides the incoming electrical power and distributes it into multiple electrical circuits 126, 128. Each of the electric circuits typically has one or more electrical outlets, such as outlets 130, 132 for example. The electrical circuits 126, 128 may be rated as 110 volt, 15 ampere circuit, a 110 volt, 20 ampere circuit, a 220 volt, 20 ampere circuit, a 220 volt, 30 ampere circuit, or a 220V, 50 ampere circuit for example. In some embodiments, the electrical circuits 126, 128 may be a 400-480 volt circuit. Further, while the electrical circuits 126, 128 are illustrated as a single line, the electrical circuits 126, 128 may a multi-phase circuit, such as a three phase circuit for example. In the exemplary embodiment, the outlets 130, 132 are configured with interfaces to accept industry standard plugs, such as NEMA 5-15, NEMA 5-20, NEMA 6-20, NEMA 6-30, or NEMA 6-50 plugs for example

It should be appreciated that the actual voltage supplied from the local electrical distribution network 86 may vary within industry acceptable tolerances. The voltages and currents discussed herein are for exemplary purposes and the claimed invention should not be so limited. For example a nominal 110 volt circuit may vary between 105 volts to 125 volts, and a 220 volt circuit may vary between 208 volts to 240 volts for example. The load center 124 may further have one or more additional circuits that are dedicated to a particular appliance, such as a furnace, a well pump, an oven or a clothes dryer for example.

When the vehicle operator desires to recharge the battery 116, the coupler 28 on conduit 34 is attached to receptacle 118. By connecting the coupler 28 to the receptacle 118, the output conductor 36 and communications line 38, 40 of electric vehicle charger 20 are electrically connected to corresponding conductors 134 and communication lines 136 in vehicle 106. The operator then connects the conductors 30 to the outlets 130, 132 allowing electrical power to flow from the residence 104 into the vehicle 106. Since the electrical power is being provided by two distinct electrical circuits within the residence 104, the output electrical power from the electric vehicle charger 20 to the vehicle 106 is converted by the toroidal transformer 46 to approximately twice the voltage of the individual electrical circuits 126, 128. Thus, the electric vehicle charger 20 provides the advantages of a SAE J1772 Level 2 charge in locations where only Level 1 capacity circuits are available. Further, if the residence has 220 volt circuits available, the electric vehicle charger 20 may be able to provide approximately a Level 3 charge where only Level 2 capacity circuits are available. In one embodiment, when the toroidal transformer 46 converts the voltage, the output current level is approximately half the input current level. This provides many advantages in reducing the amount of charge time for recharging the battery 116.

In one embodiment, the electric vehicle charger 20, is configured to be portable and transportable in a vehicle, such as on the rear floor or in the trunk of the vehicle. The electric vehicle charger 20 is sized to fit within constraints such as the rear seat and the front seat so as to limit the width of the electric vehicle charger 20. In the exemplary embodiment, the housing 22 of the electric vehicle charger 20 is less than 5 inches (12.7 centimeters). A vehicles front seat is typically angled to provide comfort and structural support for a front seat passenger. As such, the front seat vertically constrains the height of the electric vehicle charger 20. In the exemplary embodiment, the height of the housing 22 is less than 18 inches (45.7 centimeters). Further, in many vehicles, the length of the electric vehicle charger 20 may be constrained by an elevated portion typically located in the center of the car to allow a drive-train to pass from the engine to the rear wheels of the vehicle. In the exemplary embodiment, the width of the housing 22 of electric vehicle charger 20 is less than 18 inches (45.7 centimeters). It should be appreciated that other dimensions may be more appropriate provided that electric vehicle charger 20 remains sized to fit within the desired transportation area in a vehicle without causing damage or unnecessary wear to the vehicle. It is also desirable for the electric vehicle charger 20 to be an appropriate weight to be carried or transported by a single person. In the exemplary embodiment, the electric vehicle charger 20 has a weight of less than 60 lbs (27.2 kg).

It should be appreciated that an electric vehicle charger 20 may provide further advantages in facilitating the purchase and adoption of electrically powered vehicles. Since the electric vehicle charger 20 provides a higher level of charge, the amount of time it takes to recharge the battery 116 may be substantially reduced, such as from 24 hours with a Level 1 charge, to between three to six hours with a Level 2 charge for example. This decrease in recharge time may be accomplished without requiring substantial, or in some applications any, installation of additional electrical circuits. Thus a purchaser of an electrically powered vehicle may start fully utilizing the vehicle once it is purchased.

It should further be appreciated that the electric vehicle charger 20 provides advantages by allowing the electrically powered vehicle to be charged using standard electrical outlets. Thus, the vehicle operator may keep the electric vehicle charger 20 in vehicle allowing the recharging of the battery at the operators place of employment, such as through the use of outlets 96 for example.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An electric vehicle charger comprising:
a first electrical input, said first electrical input adapted to receive a first electrical power having a first voltage level and a first current level;
a second electrical input, said second electrical input adapted to receive said first electrical power;
a toroidal transformer electrically coupled to said first electrical input and said second electrical input, said toroidal transformer having a first output, wherein said toroidal transformer is adapted to provide a second electrical power having a second voltage level and a second current level to said first output; and,
a second output configured to electrically couple between a vehicle and said first output.

2. The electric vehicle charger of claim 1 wherein said second voltage level is substantially twice said first voltage level and said second current level is substantially half said first current level.

3. The electric vehicle charger of claim 2 wherein said second output includes a SAE J1772 compliant connector.

4. The electric vehicle charger of claim 1 further comprising a controller operably coupled to said toroidal transformer, wherein said controller limits said second current level in response to a signal.

5. The electric vehicle charger of claim 4 wherein said second output includes a coupler adapted to connect with said vehicle, said coupler having a first conductor electrically coupled to said toroidal transformer and a second conductor operably coupled to said controller.

6. The electric vehicle charger of claim 5 wherein said signal is received by said controller from said second conductor.

7. A device for charging a vehicle at a facility having a first electrical circuit and a second electrical circuit, said device comprising:
a first input electrically coupled to said first electrical circuit;
a second input electrically coupled to said second electrical circuit;
a transformer electrically coupled to said first input and said second input, said transformer being configured to combined an electrical power received from said first input and said second input; and,
an output electrically coupled to said transformer.

8. The device of claim 7 wherein said transformer is a toroidal transformer.

9. The device of claim 8 further comprising a controller operably coupled to said output and said toroidal transformer, said controller varying an output electrical power to said output in response to a first signal.

10. The device of claim 9 wherein said output further includes a coupler, said coupler being arranged to flow said electrical power to said vehicle and receive a second signal from said vehicle.

11. The device of claim 10 wherein said first input and said second input each includes a NEMA 5-15 compatible plug.

12. The device of claim 10 wherein said first input and said second input each includes a NEMA 6-30 compatible plug.

13. The device of claim 9 further comprising a housing containing said toroidal transformer and said controller, wherein said device is sized and of an appropriate weight to be carried by a single person.

14. A method of providing an electrical charge to a vehicle comprising:
providing a transformer having an input portion and an output portion;
electrically coupling said input portion to a first input conductor and a second input conductor;
connecting said first input conductor to a first electrical circuit and said second input conductor to a second electrical circuit;
electrically coupling said output portion to said vehicle.

15. The method of claim 14 further comprising:
receiving a signal from said vehicle at a controller; and,
limiting current flowing to said vehicle in response to said signal.

16. The method of claim 14 wherein said first electrical circuit and said second electrical circuit provide electrical power at substantially 110 volts and 15 ampere.

17. The method of claim 16 wherein said output portion provides electrical power at 220 volts and 7.5 ampere to said vehicle.

18. The method of claim 14 wherein said first electrical circuit and said second electrical circuit provide electrical power at substantially 220 volts and 30 ampere.

19. The method of claim 18 wherein said output portion provides electrical power at 400 volts and 30 ampere to said vehicle.
